(19) United States
(12) Patent Application Publication
(10) Pub. No.: US 2015/0268575 A1
(43) Pub. Date: Sep. 24, 2015

(54) ELECTROPHOTOGRAPHIC TONER USING BIOPLASTIC AND METHOD OF PRODUCING THE SAME

(71) Applicant: CASIO COMPUTER CO., LTD., Tokyo (JP)

(72) Inventors: Yuta KAN, Tokorozawa-shi (JP); Hideki IKEDA, Hamura-shi (JP); Yuichiro IEGAKI, Kodaira-shi (JP); Kenji KIHIRA, Kiyose-shi (JP)

(73) Assignee: CASIO COMPUTER CO., LTD., Tokyo (JP)

(21) Appl. No.: 14/660,708

(22) Filed: Mar. 17, 2015

(30) Foreign Application Priority Data
Mar. 18, 2014 (JP) 2014-055601

(51) Int. Cl. G03G 9/087; G03G 9/08

(52) U.S. Cl. CPC G03G 9/08755; G03G 9/081

(57) ABSTRACT

An electrophotographic toner having good grindability, a wide fixing temperature range and excellent durability, and a method of producing the same are provided. The electrophotographic toner includes, as a binder resin, an amorphous bioplastic having a number average molecular weight (Mn) of 5,000 to 40,000, a weight average molecular weight (Mw) of 20,000 to 60,000, and a ratio of Mw/Mn of 1.4 or more.

### CROSS-REFERENCE TO RELATED APPLICATION

This application is based upon and claims the benefit of priority from Japanese Patent Application No. 2014-055601, filed Mar. 18, 2014, the entire contents of which are incorporated herein by reference.

### FIELD

The present invention relates to an electrophotographic toner using a bioplastic, and a method of producing the same.

### BACKGROUND

Image formation by an electrophotographic method includes developing an electrostatic image with a toner to visualize the image, transferring the toner image thus obtained onto a sheet, and then fixing the toner image by applying heat and pressure thereto. The toner is produced by melting and kneading a mixture containing a binder resin, a colorant, a charge control agent or the like, and grinding and classifying the resultant mixture to adjust the particle size distribution. Petroleum resins such as a styrene-acrylic resin and a polyester resin are conventionally used as the binder resin of the toner.

In recent years, use of a biodegradable resin having a small load on the environment upon disposal or a biomass plastic made from a recyclable resource as a resin for toners has been proposed from the standpoint of environmental friendliness. Biomass plastics and biodegradable plastics which can effectively utilize limited resources and contribute to a reduction in an environment load are called “bioplastics”.

For example, a toner which mainly uses polylactic acid, which is a bioplastic, is known (Jpn. Pat. Appln. KOKAI Publication No. 2008-262179 and Jpn. Pat. Appln. KOKAI Publication No. 2007-197602). When polylactic acid is used as a binder resin for a grinded toner, polylactic acid having a low molecular weight is used, because if polylactic acid having a high molecular weight is used, it becomes difficult to grind the toner during toner production steps, or low temperature fixation is deteriorated in a fixing step. It is difficult, however, to store the toner for a long period of time when using polylactic acid having a low molecular weight, due to the influence of increased number of terminal carboxyl groups or presence of monomers.

In order to improve properties of a toner containing a bioplastic as a binder resin, it is known to use amorphous polylactic acid as the binder resin and to adjust a concentration of D-lactic acid in the amorphous polylactic acid to 10 to 40% by mole (Jpn. Pat. Appln. KOKAI Publication No. 2010-169764), but further improvements have been required.

### SUMMARY

An electrophotographic toner according to a first aspect of the present invention contains, as a binder resin, an amorphous bioplastic having a number average molecular weight (Mn) of 5,000 to 40,000, a weight average molecular weight (Mw) of 20,000 to 60,000, and a ratio of Mw/Mn of 1.4 or more.

A method of producing an electrophotographic toner according to a second aspect of the present invention includes melt-kneading a mixture containing, as a binder resin, an amorphous bioplastic having a number average molecular weight (Mn) of 5,000 to 40,000, a weight average molecular weight (Mw) of 20,000 to 60,000, and a ratio of Mw/Mn of 1.4 or more to obtain a kneaded product; and grinding the kneaded product after hardened.

### BRIEF DESCRIPTION OF THE DRAWINGS

A more complete understanding of this application can be obtained when the following detailed description is considered in conjunction with the following drawings, in which:

FIG. 1 shows a DSC (differential scanning calorimetry) curve of crystalline polylactic acid which is conventionally widely used; and

FIG. 2 shows a DSC (differential scanning calorimetry) curve of amorphous polylactic acid which is used in the present invention.

### DETAILED DESCRIPTION

Hereinafter, an embodiment of the present invention will be described.

The present inventors have studied to make improvements in properties of a bioplastic toner and as a result have found that when an amorphous bioplastic having a number average molecular weight (Mn) of 5,000 to 40,000, a weight average molecular weight (Mw) of 20,000 to 60,000, and a ratio of Mw/Mn of 1.4 or more is used as a binder resin, grindability is improved, a fixing temperature range is expanded, and a toner durability is improved, thus completing the present invention.

An electrophotographic toner according to one embodiment of the present invention contains, as a binder resin, an amorphous bioplastic having a number average molecular weight (Mn) of 5,000 to 40,000, a weight average molecular weight (Mw) of 20,000 to 60,000, and a ratio of Mw/Mn of 1.4 or more.

In the present embodiment, the amorphous bioplastic is used as the binder resin. The amorphous bioplastic has no exothermic peak on a DSC curve obtained from DSC (differential scanning calorimetry). On the other hand, a crystalline bioplastic has an exothermic peak on the DSC curve.

The crystalline bioplastic is harder than the amorphous bioplastic, which leads to a degraded grindability, and thus in the present embodiment, the toner does not contain the crystalline bioplastic.

In the present embodiment, the amorphous bioplastic has a number average molecular weight (Mn) of 5,000 to 40,000 and a weight average molecular weight (Mw) of 20,000 to 60,000, a ratio of Mw/Mn being 1.4 or more.

When the number average molecular weight (Mn) of the amorphous bioplastic is not within the range described above, the durability in printing is deteriorated. When the weight average molecular weight (Mw) of the amorphous bioplastic is not within the range described above, the grindability is deteriorated, thus resulting in reduced productivity. When the ratio of Mw/Mn is less than 1.4, the fixing temperature range is reduced.

The amorphous bioplastic has preferably a number average molecular weight (Mn) of 20,000 to 30,000. The amorphous bioplastic has preferably a weight average molecular weight (Mw) of 25,000 to 35,000. The ratio of Mw/Mn in the amorphous bioplastic is preferably from 1.4 to 4.0, more preferably from 1.4 to 3.5.

The number average molecular weight and the weight average molecular weight of the amorphous bioplastic can be adjusted by adjusting an amount of a catalyst added upon ring-opening polymerization according to a conventional technique.

In the present embodiment, the amorphous bioplastic may be produced by ring-opening polymerization, using lactide obtained from corn or cassava as a starting material.

In the present embodiment, amorphous polylactic acid can be used as the amorphous bioplastic. The amorphous polylactic acid has preferably a D-lactic acid concentration of 10 to 40% by mole.

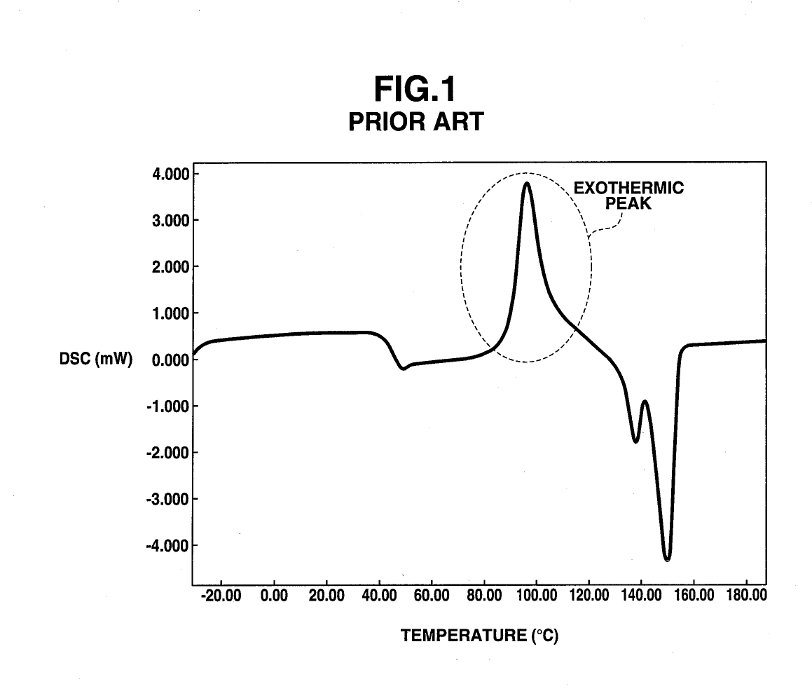

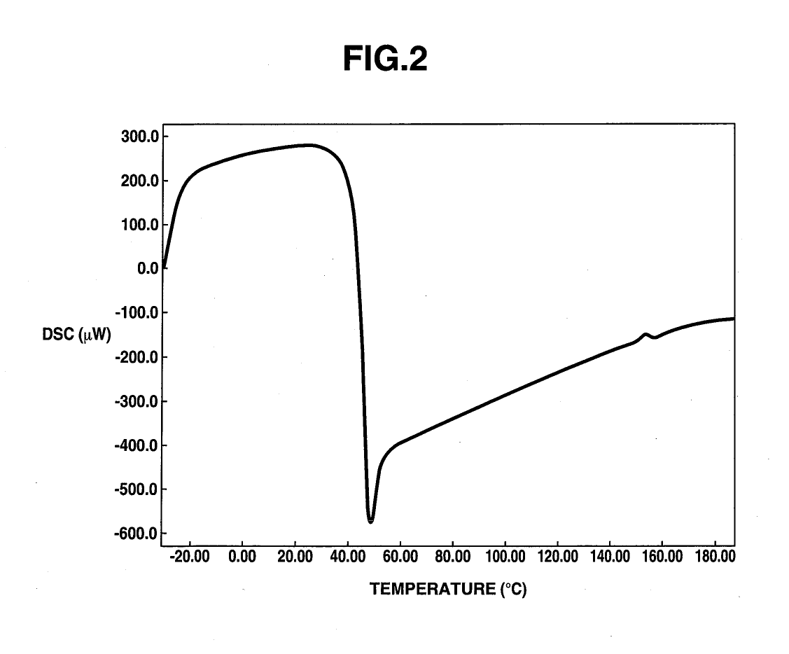

FIG. 1 shows a DSC curve of crystalline polylactic acid which is conventionally widely used, and FIG. 2 shows a DSC curve of amorphous polylactic acid which is used in the present invention. As shown in FIG. 1 and FIG. 2, in the crystalline polylactic acid, an exothermic peak is observed on the DSC curve; whereas in the amorphous polylactic acid, no exothermic peak is observed on the DSC curve.

The toner according to the present embodiment can further contain a colorant as a toner raw material. As the colorant, a conventionally known colorant can be used. Examples of a black colorant include carbon black; examples of a blue colorant include C. I. Pigment 15:3; examples of a red colorant include C. I. Pigments 57:1, 122, and 269; and examples of a yellow colorant include C. I. Pigments 74, 180 and 185. In consideration of the effect on the environment, a colorant in itself having high safety is preferable.

The content of the colorant is preferably 1 to 10% by mass based on the toner mass. A master batch is prepared by dispersing the colorant at a high concentration in a resin, and the obtained master batch may also be used as the colorant. In the present specification, the “toner mass” is defined as the total mass of toner raw materials containing the binder resin and the colorant, which does not include an external additive such as silica.

To the toner according to the present embodiment, a conventionally known release agent can be added if needed. Examples of the release agent include olefin-based wax such as polypropylene wax, polyethylene wax, or Fisher-Tropsch wax; natural wax such as carnauba wax, rice wax, or scale insect wax; and synthetic ester wax.

In order to improve low temperature fixability and high speed printing performance, a release agent having a comparatively low melting point of about 60 to 100° C. is preferable. Specifically, the carnauba wax or the synthetic ester wax is preferable. In consideration of the effect on the environment, natural product-based carnauba wax is more preferable. The content of the release agent is preferably 1 to 15% by mass based on the toner mass.

To the toner according to the present embodiment, a conventionally known charge control agent can be added if needed as the raw material. Examples of a positive charge control agent include a resin containing a quarternary ammonium salt or an amino group. Examples of a negative charge control agent include a resin containing a metal complex salt of salicylic acid, a metal complex salt of benzilic acid, a calixarene type phenol-based condensate, or a carboxyl group. The content of the charge control agent is preferably 0.1 to 5% by mass based on the toner mass.

To the toner according to the present embodiment, a conventionally known resin for toners can be added if needed in addition to the bioplastic. Examples of the resin include a styrene resin, an acrylic resin, and a polyester resin. A polyester resin which has been developed for use as a toner is preferable in terms of pigment dispersibility and low temperature fixability. The resins may be used alone or as a mixture of two or more kinds. The content of the resin is preferably 0 to 50% by mass based on the toner mass, in consideration of the effect on the environment.

A low molecular weight resin may be added as another material in order to improve grindability, fixability, and the like. Herein, the low molecular weight resin refers to a resin classified as an oligomer with a molecular weight of from several hundred to several thousand, which is commercially available as a tackifier. Examples thereof include rosin, a rosin derivative, a polyterpene resin, a terpene phenol resin, and a petroleum resin.

To the toner according to the present embodiment, a conventionally known hydrolysis inhibitor can be added if needed. Examples of the hydrolysis inhibitor include a carbodiimide-based compound, an isocyanate-based compound, and an oxazoline-based compound. Such a hydrolysis inhibitor can block a terminal hydroxyl group or carboxyl group generated from residual monomers or by decomposition, to suppress a hydrolysis chain reaction.

As the hydrolysis inhibitor, Carbodilite LA-1 (manufactured by Nisshinbo Industries Inc.), which is a polycarbodiimide compound, is commercially available. The amount of the hydrolysis inhibitor to be added is preferably 0.01 to 15% by mass based on the bioplastic, and more preferably 1 to 10% by mass based on the bioplastic.

To the toner according to the present embodiment, a conventionally known crystal nucleating agent can be added if needed. Examples of the crystal nucleating agent include an inorganic nucleating agent such as talc; and an organic nucleating agent such as an organic carboxylic acid metal salt (such as sodium benzoate), a phosphoric ester metal salt, benzylidene sorbitol and carboxylic acid amide.

The electrophotographic toner described above can be produced according to a conventionally known method.

For example, a raw material which contains a binder resin containing an amorphous bioplastic, a colorant, and, if necessary, another additive is mixed, and then the resulting mixture is kneaded through a kneader such as a twin shaft kneader, a pressure kneader, or an open roll kneader to obtain a kneaded product. After the obtained kneaded product is cooled, it is ground by using a grinder such as a jet mill, and the resulting product is classified by using an air classifier, thereby obtaining a toner.

Herein, the particle diameter of the toner is not particularly limited, and it is adjusted generally to 5 to 10 μm. To the thus obtained toner, an external additive can be added in order to improve the flowability, to adjust the electrostatic property and to improve the durability.

As the external additive, inorganic fine particles are generally used, and examples thereof include silica, titania, and alumina. Among them, silica which is subjected to a hydrophobizing treatment (commercially available from Nippon Aerosil Co., Ltd. and CABOT Inc.) is preferable. The inorganic fine particles preferably have a primary particle diameter of 7 to 40 nm. Two or more kinds of the inorganic fine particles may be mixed in order to improve a function.

### EXAMPLES

The present invention will be explained in more detail below by comparing Examples of the present invention with Comparative Examples.

<Differential Scanning Calorimetry>

Differential scanning calorimetry of crystalline polylactic acid and amorphous polylactic acid was performed.

Crystalline polylactic acid having a number average molecular weight of 80,000 and a weight average molecular weight of 180,000, manufactured by Hisun Biomaterial Co., Ltd., was used as the crystalline polylactic acid. Amorphous polylactic acid having a number average molecular weight of 30,000 and a weight average molecular weight of 55,000, manufactured by Toyobo Co., Ltd., was used as the amorphous polylactic acid.

Using DSC 6220, manufactured by SII, the temperature was increased from −30° C. to 200° C. at a rate of 10° C./minute, and then it was decreased to −30° C. A DSC curve was obtained when the temperature was increased again from −30° C. to 200° C. at a rate of 10° C./minute. The obtained DSC curves of the crystalline polylactic acid and amorphous polylactic acid are respectively shown in FIG. 1 and FIG. 2. For the crystalline polylactic acid, an exothermic peak was observed on the DSC curve, but regarding the amorphous polylactic acid, no exothermic peak was observed on the DSC curve.

<Preparation of Amorphous Polylactic Acid>

In the Examples and Comparative Examples, the amorphous polylactic acid shown in Table 1 below was used.

TABLE 1

| | Number average | Weight average | |
|---|---|---|---|
| | molecular weight | molecular weight | |
| | (Mn) | (Mw) | Mw/Mn |
| Amorphous | 40,000 | 60,000 | 1.50 |
| polylactic acid A | | | |
| Amorphous | 30,000 | 50,000 | 1.66 |
| polylactic acid B | | | |
| Amorphous | 20,000 | 40,000 | 2.00 |
| polylactic acid C | | | |
| Amorphous | 10,000 | 30,000 | 3.00 |
| polylactic acid D | | | |
| Amorphous | 5,000 | 20,000 | 4.00 |
| polylactic acid E | | | |
| Amorphous | 35,000 | 50,000 | 1.42 |
| polylactic acid F | | | |
| Amorphous | 25,000 | 40,000 | 1.60 |
| polylactic acid G | | | |
| Amorphous | 20,000 | 30,000 | 1.50 |
| polylactic acid H | | | |
| Amorphous | 10,000 | 20,000 | 2.00 |
| polylactic acid I | | | |
| Amorphous | 50,000 | 60,000 | 1.20 |
| polylactic acid J | | | |
| Amorphous | 40,000 | 70,000 | 1.75 |
| polylactic acid K | | | |
| Amorphous | 40,000 | 50,000 | 1.25 |
| polylactic acid L | | | |
| Amorphous | 30,000 | 40,000 | 1.33 |
| polylactic acid M | | | |
| Amorphous | 25,000 | 30,000 | 1.20 |
| polylactic acid N | | | |
| Amorphous | 15,000 | 20,000 | 1.33 |
| polylactic acid O | | | |
| Amorphous | 5,000 | 10,000 | 2.00 |
| polylactic acid P | | | |
| Amorphous | 2,000 | 20,000 | 10.00 |
| polylactic acid Q | | | |
| Amorphous | 2,000 | 10,000 | 5.00 |
| polylactic acid R | | | |

The amorphous polylactic acids were prepared by any of the following methods: a ring-opening polymerization method using lactide, which is a dimer of lactic acid monomers; a method in which lactic acid was directly subjected to a dehydration polycondensation in an organic solvent; a method in which powdery or particulate polylactic acid having a low molecular weight was heated in an inert gas atmosphere or in vacuo at a given temperature to increase the molecular weight; and a method in which crystallized polylactic acid having a low molecular weight was subjected to solid phase polymerization in the presence of a catalyst to produce polylactic acid having a high molecular weight.

### Production of Toner

### Example 1

Using the polylactic acid described above as the binder resin, a toner was produced as described below.

Using a Henschel mixer (manufactured by Mitsui Mining Co., Ltd.), amorphous polylactic acid A, and pigments (magenta: SEIKAFAST CARMINE 1476T-7 (manufactured by Dainichiseika Color & Chemicals Mfg. Co., Ltd.), cyan: Cyanine Blue 4920 (manufactured by Dainichiseika Color & Chemicals Mfg. Co., Ltd.), yellow: Paliotol Yellow D1155 (manufactured by BASF Japan Ltd.), and black: Carbon Black MOGUL-L (manufactured by Cabot Specialty Chemicals, Inc.)) were mixed. Subsequently, the mixture was melt-kneaded through a twin screw extruder (manufactured by Ikegai Corp.). The resulting kneaded product was drawn in a cooling condition, and was ground in a Feather mill (manufactured by Hosokawa Micron Corporation) into a size of 2 mm or less, thereby obtaining a master batch.

The obtained pigment master batch, a binder resin, a release agent, a charge control agent, and a terpene-based resin were stirred in a Henschel mixer, and then the mixture was melt-kneaded in a twin screw extruder. After the kneaded product was cooled, it was ground using a collision type grinder (manufactured by Nippon Pneumatic Mfg. Co., Ltd. (NPK)), and classified using an air classifier (manufactured by NPK) to obtain a powder having an average particle diameter of 9 μm. To the obtained powder was added hydrophobic silica RX200 (manufactured by Nippon Aerosil Co., Ltd.) as an external additive in an amount of one part by mass based on 100 parts by mass of the binder resin, and the mixture was stirred in the Henschel mixer whereby the powder was subjected to a surface treatment, thus obtaining a toner.

In the present Example, 100 parts by mass of the amorphous polylactic acid A as the binder resin, 4 parts by mass of the pigment master batch prepared as described above, 3 parts by mass of carnauba wax No. 1 powder (manufactured by Nippon Wax Co., Ltd.) as the release agent, one part by mass of LR-147 (manufactured by Japan Carlit Co., Ltd.) as the charge control agent, and one part by mass of a terpene-based resin, Clearon P135 (manufactured by Yasuhara Chemical Co., Ltd.; a hydrogenated terpene resin with a softening point of 135° C.) as the low molecular weight resin were used.

### Examples 2 to 9

A toner was produced in the same manner as in Example 1 except that amorphous polylactic acid B to I (see Table 1) were used as the binder resin.

### Comparative Example 1

A toner was produced in the same manner as in Example 1 except that crystalline polylactic acid (which had a number average molecular weight of 80,000 and a weight average molecular weight of 180,000, manufactured by Hisun Biomaterial Co., Ltd.) was used instead of the amorphous polylactic acid as the binder resin.

### Comparative Examples 2 to 10

A toner was produced in the same manner as in Example 1 except that amorphous polylactic acid J to R (see Table 1) were used as the binder resin.

The grindability, the productivity, the fixing temperature range, and the durability of each toner were measured and evaluated. Evaluation method and evaluation criterion are shown below.

### Experiment 1

### Grindability

The grindability of the toner was evaluated as described below, using the kneaded, crudely ground particles.

(1) Kneaded, crudely ground particles are passed through two overlapping sieves having an aperture of 1 mm and an aperture of 0.71 mm.

(2) 10 g of the obtained crudely ground particles having a particle diameter of 1 mm or less and 0.71 mm or more are collected.

(3) 10 g of the crudely ground particles are ground for 10 seconds in a mill (Miniblender MB-2: Osaka Chemical Co., Ltd.).

(4) The ground particles are sieved for 10 minutes on a 0.71 mm sieve.

(5) The mass of the crudely ground particles which remain on the sieve is measured, and a grindability index is calculated according to the following formula:

Grindability Index=100−{(mass of the crudely ground particles/10)*100}

The grindability of the toner was evaluated according to the following evaluation criteria:

(Evaluation Criteria)

A: 50% or more in grindability index

C: less than 50% in grindability index

### Experiment 2

### Productivity

The Productivity was judged by the yield (% by mass) of toner base particles, when the kneaded, crudely ground particles were ground and classified in the grinding and classification steps, and the evaluation was performed according to the following criteria. Actually, there was no problem if the yield was 70% or more. The grinding conditions were adjusted so that the toner had a volume average particle diameter of 9 μm, and included fine particles having a particle diameter of 3 μm or less in a number percentage of particles of 5% or less and coarse particles having a particle diameter of 16 μm or more in a volume percentage of particles of 3% or less.

(Evaluation Criteria)

A: 70% or more of a yield

B: 50% or more and less than 70% of a yield

C: less than 50% of a yield

### Experiment 3

### Fixing Temperature Range

The toner was placed in a “SPEEDIA-GE6000” (color printer for printing 38 sheets per minute, manufactured by Casio Computer Co., Ltd), and 100% solid printing was performed on plain paper sheets (XEROX-P paper, A4 size) within a range of ¼ from the printing tip in a transverse manner of the A4 paper. The fixing temperature was varied by increasing from 130° C. to 190° C. at a 10° C.-pitch. It was checked whether or not there were stains on the non-printed area and whether or not there were stains on a tissue paper with which the printed area was rubbed. Whether no stain was observed in a temperature range of 50° C. or higher was evaluated.

(Evaluation Criteria)

A: No stain was observed in a temperature range of 50° C. or higher.

C: No stain was observed in a temperature range of less than 50° C.

### Experiment 4

### Durability

The durability was evaluated by placing the toner in a “SPEEDIA-GE6000” (color printer for printing 38 sheets per minute, manufactured by Casio Computer Co., Ltd), and continuously performing 5% image printing on 10,000 sheets in a normal environment (25° C. and 50% RH). 100% solid printing of the A4 sheet was performed every 1,000 sheets and the sheets were sampled. The presence or absence of an image defect on the image sample was visually observed.

(Evaluation Criteria)

A: Image defect was hardly observed.

C: Image defect was observed.

The results from Experiments 1 to 4 are shown in Table 2 and Table 3 described below.

TABLE 2

| | Composition | | | | | | |
|---|---|---|---|---|---|---|---|
| | Amorphous | Amorphous | Amorphous | Amorphous | Amorphous | Amorphous | Amorphous |
| | polylactic | polylactic | polylactic | polylactic | polylactic | polylactic | polylactic |
| | acid A | acid B | acid C | acid D | acid E | acid F | acid G |
| | Number | Number | Number | Number | Number | Number | Number |
| | average | average | average | average | average | average | average |
| | molecular | molecular | molecular | molecular | molecular | molecular | molecular |
| | weight: | weight: | weight: | weight: | weight: | weight: | weight: |
| | 40,000 | 30,000 | 20,000 | 10,000 | 5,000 | 35,000 | 25,000 |
| | Weight | Weight | Weight | Weight | Weight | Weight | Weight |
| | average | average | average | average | average | average | average |
| | molecular | molecular | molecular | molecular | molecular | molecular | molecular |
| | weight: | weight: | weight: | weight: | weight: | weight: | weight: |
| | 60,000 | 50,000 | 40,000 | 30,000 | 20,000 | 50,000 | 40,000 |
| | Mw/Mn | | | | | | |
| | 1.50 | 1.66 | 2.00 | 3.00 | 4.00 | 1.42 | 1.60 |
| Example 1 | 100 | | | | | | |
| Example 2 | | 100 | | | | | |
| Example 3 | | | 100 | | | | |
| Example 4 | | | | 100 | | | |
| Example 5 | | | | | 100 | | |
| Example 6 | | | | | | 100 | |
| Example 7 | | | | | | | 100 |
| Example 8 | | | | | | | |
| Example 9 | | | | | | | |
| | Composition | | | | | | |
| | Amorphous | Amorphous | | | | | |
| | polylactic | polylactic | | | | | |
| | acid H | acid I | | | | | |
| | Number | Number | | | | | |
| | average | average | | | | | |
| | molecular | molecular | Pigment | | | | |
| | weight: | weight: | (SEIKA- | | | | |
| | 20,000 | 10,000 | FAST | Terpene- | | | |
| | Weight | Weight | CARMINE, | based | | | |
| | average | average | Cyanine | resin | | | Hydrophobic |
| | molecular | molecular | Blue, | (Yasuhara | Carnauba | | silica |
| | weight: | weight: | Paliotol | Chemical | wax | LR-147 | RX200 |
| | 30,000 | 20,000 | Yellow, and | Co., Ltd.) | (Nippon | (Japan | (Nippon |
| | Mw/Mn | | Carbon | Clearon | Wax Co., | Carlit Co., | Aerosil Co., |
| | 1.50 | 2.00 | Black) | P135 | Ltd.) | Ltd.) | Ltd.) |
| Example 1 | | | 4 | 5 | 3 | 1 | 1 |
| Example 2 | | | 4 | 5 | 3 | 1 | 1 |
| Example 3 | | | 4 | 5 | 3 | 1 | 1 |
| Example 4 | | | 4 | 5 | 3 | 1 | 1 |
| Example 5 | | | 4 | 5 | 3 | 1 | 1 |
| Example 6 | | | 4 | 5 | 3 | 1 | 1 |
| Example 7 | | | 4 | 5 | 3 | 1 | 1 |
| Example 8 | 100 | | 4 | 5 | 3 | 1 | 1 |
| Example 9 | | 100 | 4 | 5 | 3 | 1 | 1 |

Evaluation results

| | | | Fixing temperature | |
|---|---|---|---|---|
| | Grindability | Productivity | range | Durability |
| Example 1 | A | A | A | A |
| Example 2 | A | A | A | A |
| Example 3 | A | A | A | A |
| Example 4 | A | A | A | A |
| Example 5 | A | A | A | A |
| Example 6 | A | A | A | A |
| Example 7 | A | A | A | A |
| Example 8 | A | A | A | A |
| Example 9 | A | A | A | A |

TABLE 3

| | Composition | | | | | | | |
|---|---|---|---|---|---|---|---|---|
| | | Amorphous | Amorphous | Amorphous | Amorphous | Amorphous | Amorphous | Amorphous |
| | | polylactic | polylactic | polylactic | polylactic | polylactic | polylactic | polylactic |
| | | acid J | acid K | acid L | acid M | acid N | acid O | acid P |
| | | Number | Number | Number | Number | Number | Number | Number |
| | | average | average | average | average | average | average | average |
| | | molecular | molecular | molecular | molecular | molecular | molecular | molecular |
| | | weight: | weight: | weight: | weight: | weight: | weight: | weight: |
| | | 50,000 | 40,000 | 40,000 | 30,000 | 25,000 | 15,000 | 5,000 |
| | | Weight | Weight | Weight | Weight | Weight | Weight | Weight |
| | | average | average | average | average | average | average | average |
| | | molecular | molecular | molecular | molecular | molecular | molecular | molecular |
| | | weight: | weight: | weight: | weight: | weight: | weight: | weight: |
| | Crystalline | 60,000 | 70,000 | 50,000 | 40,000 | 30,000 | 20,000 | 10,000 |
| | polylactic | Mw/Mn | | | | | | |
| | acid | 1.20 | 1.75 | 1.25 | 1.33 | 1.20 | 1.33 | 2.00 |
| Comparative | 100 | | | | | | | |
| example 1 | | | | | | | | |
| Comparative | | 100 | | | | | | |
| example 2 | | | | | | | | |
| Comparative | | | 100 | | | | | |
| example 3 | | | | | | | | |
| Comparative | | | | 100 | | | | |
| example 4 | | | | | | | | |
| Comparative | | | | | 100 | | | |
| example 5 | | | | | | | | |
| Comparative | | | | | | 100 | | |
| example 6 | | | | | | | | |
| Comparative | | | | | | | 100 | |
| example 7 | | | | | | | | |
| Comparative | | | | | | | | 100 |
| example 8 | | | | | | | | |
| Comparative | | | | | | | | |
| example 9 | | | | | | | | |
| Comparative | | | | | | | | |
| example 10 | | | | | | | | |

| | Composition | | | | | | |
|---|---|---|---|---|---|---|---|
| | Amorphous | Amorphous | | | | | |
| | polylactic | polylactic | | | | | |
| | acid Q | acid R | | | | | |
| | Number | Number | | | | | |
| | average | average | | | | | |
| | molecular | molecular | Pigment | | | | |
| | weight: | weight: | (SEIKA- | | | | |
| | 2,000 | 2,000 | FAST | Terpene- | | | |
| | Weight | Weight | CARMINE, | based | | | |
| | average | average | Cyanine | resin | | | Hydrophobic |
| | molecular | molecular | Blue, | (Yasuhara | Carnauba | LR-147 | silica |
| | weight: | weight: | Paliotol | Chemical | wax | (Japan | RX200 |
| | 20,000 | 10,000 | Yellow, and | Co., Ltd.) | (Nippon | Carlit | (Nippon |
| | Mw/Mn | | Carbon | Clearon | Wax Co., | Co., | Aerosil |
| | 10.00 | 5.00 | Black) | P135 | Ltd.) | Ltd.) | Co., Ltd.) |
| Comparative | | | 4 | 5 | 3 | 1 | 1 |
| example 1 | | | | | | | |
| Comparative | | | 4 | 5 | 3 | 1 | 1 |
| example 2 | | | | | | | |
| Comparative | | | 4 | 5 | 3 | 1 | 1 |
| example 3 | | | | | | | |
| Comparative | | | 4 | 5 | 3 | 1 | 1 |
| example 4 | | | | | | | |
| Comparative | | | 4 | 5 | 3 | 1 | 1 |
| example 5 | | | | | | | |
| Comparative | | | 4 | 5 | 3 | 1 | 1 |
| example 6 | | | | | | | |
| Comparative | | | 4 | 5 | 3 | 1 | 1 |
| example 7 | | | | | | | |
| Comparative | | | 4 | 5 | 3 | 1 | 1 |
| example 8 | | | | | | | |
| Comparative | 100 | | 4 | 5 | 3 | 1 | 1 |
| example 9 | | | | | | | |
| Comparative | | 100 | 4 | 5 | 3 | 1 | 1 |
| example 10 | | | | | | | |

Evaluation results

| | | | Fixing temperature | |
|---|---|---|---|---|
| | Grindability | Productivity | range | Durability |
| Comparative | C | C | C | A |
| example 1 | | | | |
| Comparative | A | A | C | C |
| example 2 | | | | |
| Comparative | C | C | A | A |
| example 3 | | | | |
| Comparative | A | A | C | A |
| example 4 | | | | |
| Comparative | A | A | C | A |
| example 5 | | | | |
| Comparative | A | A | C | A |
| example 6 | | | | |
| Comparative | A | A | C | A |
| example 7 | | | | |
| Comparative | A | B | A | A |
| example 8 | | | | |
| Comparative | A | A | A | C |
| example 9 | | | | |
| Comparative | A | B | A | C |
| example 10 | | | | |

In Examples 1 to 9, the amorphous polylactic acid having a number average molecular weight (Mn) of 5,000 to 40,000, a weight average molecular weight (Mw) of 20,000 to 60,000, and a ratio of Mw/Mn of 1.4 or more was used as the binder resin. As a result, in Examples 1 to 9, good results could be obtained in all of the grindability, the productivity, the fixing temperature range, and the durability.

In Comparative Example 1, the crystalline polylactic acid was used as the binder resin. As a result, good results could not be obtained in the grindability, the productivity, and the fixing temperature range.

In Comparative Example 2, the amorphous polylactic acid whose number average molecular weight (Mn) was 50,000, which was very far from the range defined in the present invention, and whose ratio of Mw/Mn was less than 1.4 was used. As a result, good results could not be obtained in the fixing temperature range and the durability.

In Comparative Example 3, the amorphous polylactic acid whose weight average molecular weight (Mw) was 70,000, which was very far from the range defined in the present invention, was used. As a result, good results could not be obtained in the grindability and the productivity.

In Comparative Examples 4 to 7, the amorphous polylactic acid whose number average molecular weight and weight average molecular weight were within the range defined in the present invention but whose ratio of Mw/Mn was less than 1.4 was used. As a result, a good result could not be obtained in the fixing temperature range.

In Comparative Example 8, the amorphous polylactic acid whose weight average molecular weight (Mw) was small, 10,000, which was not within the range defined in the present invention, was used. As a result, a good result could not be obtained in the productivity.

In Comparative Example 9, the amorphous polylactic acid whose number average molecular weight (Mn) was small, 2,000, which was not within the range defined in the present invention, was used. As a result, a good result could not be obtained in the durability.

In Comparative Example 10, the amorphous polylactic acid whose number average molecular weight (Mn) was small, 2,000, which was not within the range defined in the present invention, and whose weight average molecular weight (Mw) was small, 10,000, which was not within the range defined in the present invention, was used. As a result, good results could not be obtained in the productivity and the durability.

From the results described above, it is found that when the amorphous bioplastic having a number average molecular weight (Mn) of 5,000 to 40,000, a weight average molecular weight (Mw) of 20,000 to 60,000, and a ratio of Mw/Mn of 1.4 or more was used as the binder resin, toner having the good results in all of the grindability, the productivity, the fixing temperature range, and the durability could be produced.

Having described and illustrated the principles of this application by reference to one preferred embodiment, it should be apparent that the preferred embodiment may be modified in terms of arrangement and details without departing from the principles disclosed herein, and that the application should be construed as including all such modifications and variations insofar as they come within the spirit and scope of the subject matter disclosed herein.

1. An electrophotographic toner comprising, as a binder resin, an amorphous bioplastic having a number average molecular weight (Mn) of 5,000 to 40,000, a weight average molecular weight (Mw) of 20,000 to 60,000, and a ratio of Mw/Mn of 1.4 or more.

2. The electrophotographic toner according to claim 1, wherein the amorphous bioplastic has a number average molecular weight (Mn) of 20,000 to 30,000.

3. The electrophotographic toner according to claim 1, wherein the amorphous bioplastic has a weight average molecular weight (Mw) of 25,000 to 35,000.

4. The electrophotographic toner according to claim 1, wherein the amorphous bioplastic is amorphous polylactic acid.

5. The electrophotographic toner according to claim 1, wherein the amorphous bioplastic is produced using lactide obtained from corn or cassava.

6. A method of producing an electrophotographic toner, comprising:
melt-kneading a mixture comprising, as a binder resin, an amorphous bioplastic having a number average molecular weight (Mn) of 5,000 to 40,000, a weight average molecular weight (Mw) of 20,000 to 60,000, and a ratio of Mw/Mn of 1.4 or more to obtain a kneaded product; and
grinding the kneaded product after hardened.

7. The method according to claim 6, wherein the amorphous bioplastic has a number average molecular weight (Mn) of 20,000 to 30,000.

8. The method according to claim 6, wherein the amorphous bioplastic has a weight average molecular weight (Mw) of 25,000 to 35,000.

9. The method according to claim 6, wherein the amorphous bioplastic is amorphous polylactic acid.

10. The method according to claim 6, wherein the amorphous bioplastic is produced using lactide obtained from corn or cassava.
